(19) United States
(12) Patent Application Publication
(10) Pub. No.: US 2009/0184112 A1
(43) Pub. Date: Jul. 23, 2009

(54) EXTENDED WIDTH SHIPPING CONTAINER AND METHOD OF SHIPPING

(76) Inventor: Ole Henrik Nielsen, Hong Kong (CN)

Correspondence Address: CHRISTIE, PARKER & HALE, LLP, PO BOX 7068, PASADENA, CA, 91109-7068, US

(21) Appl. No.: 12/016,170

(22) Filed: Jan. 17, 2008

(51) Int. Cl. B65D 88/00; B65D 43/16; G06Q 90/00

(52) U.S. Cl. 220/1.5; 220/810; 705/26

(57) ABSTRACT

Shipping containers that are wider than standard 8-foot (2.44 m) wide shipping containers and methods of shipping such extended width shipping containers are disclosed. The extended width shipping containers include: a roof; a base; a front end; a back end; two side panels; at least one door rotatable about a door rotation axis substantially perpendicular to the roof and the base; two pairs of end rails substantially perpendicular to the roof and the base; and two pairs of corner posts substantially perpendicular to the two side panels and the door rotation axis; wherein the corner posts are configured to support a greater compressive load than the end rails. Methods of shipping an extended width shipping container include: loading the shipping container with cargo; rotating the shipping container to a shipping orientation; placing the shipping container in an 8-foot (2.44 m) wide container cell of a ship; shipping the shipping container; removing the shipping container from the container cell; rotating the shipping container to a storage orientation; unloading the shipping container; transporting the shipping container over land; and utilizing the shipping container for storage of goods.

### BACKGROUND OF THE INVENTION

The present invention relates to shipping containers, and more particularly to shipping containers having an extended width and methods of shipping the same.

Shipping containers are used to transport goods across oceans on large ships, and across land on truck beds. In order to transport shipping containers across seas, the shipping containers must conform to the Convention of Safe Containers, which determines the dimensions and load capacities of different shipping containers. Shipping containers of standard dimensions are generally loaded into container cells of a ship and stacked one upon another for transport. For example, it is known to provide shipping containers measuring 8 feet (2.44 m) in width and either 20 feet (6.10 m) or 40 feet (12.19 m) in length for loading into container cells of a ship, the container cells having approximately these same standard dimensions.

Shipping containers are also used to store items at construction sites, homes, and other locations where storage is desired, and can be used accordingly upon completion of shipping. Different sizes of shipping containers may be desired according to the various applications for which the shipping container may be used. For example, shipping containers measuring 9½ (2.90 m) or 10 feet (3.05 m) in width may be desired for various storage applications.

It is known to construct a shipping container having a width of 10 feet (3.05 m) and a height of 8½ feet (2.59 m). However, a shipping container with these dimensions cannot be transported in a standard 8-foot (2.44 m) wide container cell of a ship.

It is also known to construct shipping containers having non-standard sizes to be used for various storage applications, and it is known to ship such non-standard sized containers by nesting smaller containers inside larger containers. Again, however, shipping containers having such non-standard dimensions cannot be shipped in standard 8-foot (2.44 m) wide ship container cells.

### SUMMARY OF THE INVENTION

Aspects of embodiments of the present invention are directed toward shipping containers having widths greater than a standard 8-foot (2.44 m) wide shipping container, and methods of shipping such extended width containers. Other aspects of embodiments of the present invention include shipping containers having widths of between 8½ feet (2.59 m) and 10 feet (3.05 m), such widths having special applications as storage containers after they have been used to ship goods or other containers. Other aspects of embodiments of the present invention include providing extended width shipping containers having a height of 8 feet (2.44 m) so that the containers can be turned 90 degrees on their sides to be shipped in a standard 8-foot (2.44 m) wide container cell. Still another aspect of embodiments of the present invention includes adding corner posts to top and bottom edges of ends of extended width shipping containers so that extended width shipping containers can be stacked on top of each other within standard 8-foot (2.44 m) wide container cells.

A shipping container according to an embodiment of the present invention includes: a roof; a base opposite the roof; a front end connecting the roof to the base; a back end opposite the front end, the back end connecting the roof to the base; two spaced apart side panels substantially perpendicular to and connecting the roof to the base and substantially perpendicular to and connecting the front end to the back end; and at least one door rotatable about at least one door rotation axis substantially perpendicular to the roof and the base, the at least one door coupled to the back end. The shipping container also includes two pairs of end rails, each of the end rails connected to one of the ends and one of the two side panels and having a length in a direction substantially perpendicular to the roof and the base, and two pairs of corner posts, each of the corner posts connected to one of the ends and one of the group consisting of the roof and the base, and each of the corner posts having a length in a direction substantially perpendicular to the two side panels and the at least one door rotation axis. Each of the end rails is configured to support an end rail compressive load applied to the end rail in a direction substantially parallel to the direction of the length of the end rail, the end rail compressive load equal to any load less than an end rail failure load. Each of the corner posts is configured to support a corner post compressive load applied to the corner post in a direction substantially parallel to the direction of the length of the corner post, the corner post compressive load equal to any load less than a corner post failure load. The corner post failure load is greater than the end rail failure load.

In another embodiment of the invention, a shipping container includes: two side panels opposite each other, each of the two side panels having a height of approximately 8 feet (2.44 m); a base between approximately 8½ feet (2.59 m) and 10 feet (3.05 m) wide and substantially perpendicular to and connecting the two side panels, the base comprising a plurality of cross members and a floor supported by the plurality of cross members, the base configured to support a cargo load greater than can be supported by the two side panels; two pairs of end rails, each of the end rails having a length in a direction substantially perpendicular to the base; and two pairs of corner posts, each of the corner posts having a length in a direction substantially perpendicular to the two side panels. Each of the end rails is configured to support an end rail compressive load applied to the end rail in a direction substantially parallel to the direction of the length of the end rail, the end rail compressive load equal to any load less than an end rail failure load. Each of the corner posts is configured to support a corner post compressive load applied to the corner post in a direction substantially parallel to the direction of the length of the corner post, the corner post compressive load equal to any load less than a corner post failure load. The corner post failure load is greater than the end rail failure load.

In another embodiment of the invention, a method of shipping a shipping container having a height of approximately 8 feet (2.44 m), a width between approximately 8½ feet (2.59 m) and approximately 10 feet (3.05 m), a length in a direction of a length axis, at least one door, a storage orientation wherein the at least one door is rotatable about a vertical axis, and a shipping orientation wherein the at least one door is rotatable about a horizontal axis includes: removing the shipping container from a container cell of a ship, the container cell having a width of approximately 8 feet (2.44 m), and the shipping container having been in the container cell in the shipping orientation; and rotating the shipping container approximately ninety degrees about the length axis from the shipping orientation to the storage orientation.

In one embodiment, a method of shipping a shipping container further includes: placing the shipping container in the container cell of the ship in the shipping orientation; and shipping the shipping container.

In one embodiment, a method of shipping a shipping container further includes rotating the shipping container approximately ninety degrees about the length axis from the storage orientation to the shipping orientation before placing the shipping container in the container cell of the ship.

In one embodiment, a method of shipping a shipping container further includes loading the shipping container with cargo before shipping the shipping container.

In one embodiment, a method of shipping a shipping container further includes unloading at least some of the cargo from the shipping container after shipping the shipping container.

In one embodiment, a method of shipping a shipping container further includes stacking the shipping container on another shipping container.

In one embodiment, a method of shipping a shipping container further includes transporting the shipping container over land.

In one embodiment, a method of shipping a shipping container further includes utilizing the shipping container for storage of goods after rotating the shipping container from the shipping orientation to the storage orientation.

In one embodiment, a method of shipping a shipping container further includes renting the shipping container for shipping a load of cargo.

In one embodiment, a method of shipping a shipping container further includes selling and delivering the shipping container after shipping the shipping container.

### BRIEF DESCRIPTION OF THE DRAWINGS

These and other features, aspects, and advantages of the present invention will become better understood with regard to the following description, appended claims, and accompanying drawings where:

FIG. 1 is a side perspective view of a shipping container according to an embodiment of the present invention;

FIG. 2 is an end view of the back end of the shipping container of FIG. 1;

FIG. 3 is an end view of the front end of the shipping container of FIG. 1;

FIG. 4 is an end view of three stacked shipping containers according to an embodiment of the present invention; and

FIG. 5 is a flow diagram of a method of shipping an extended width shipping container according to aspects of the present invention.

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

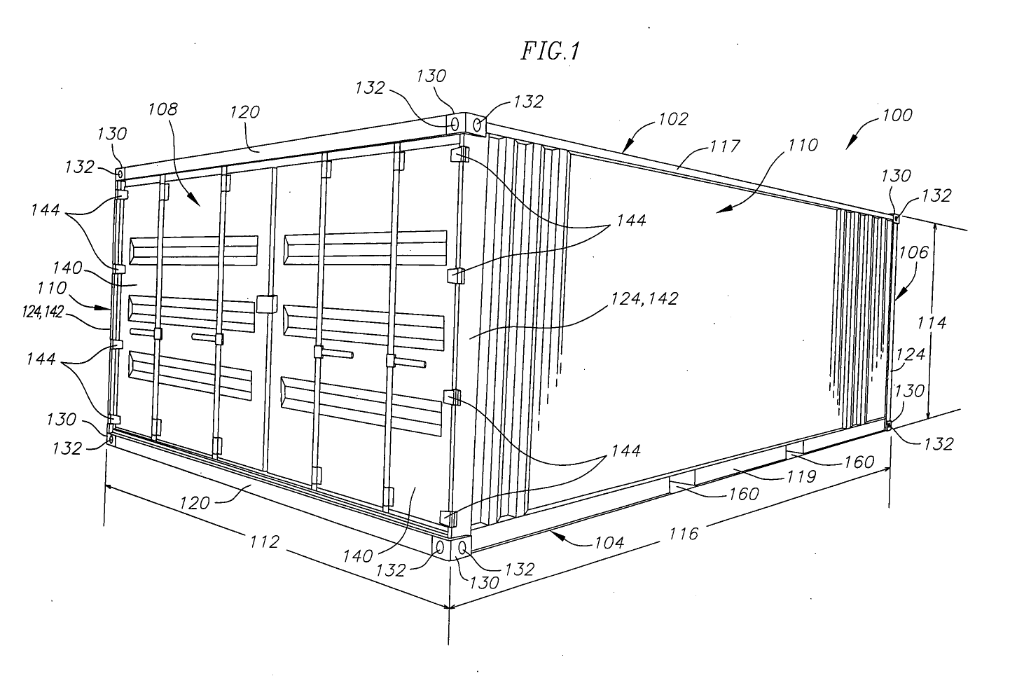

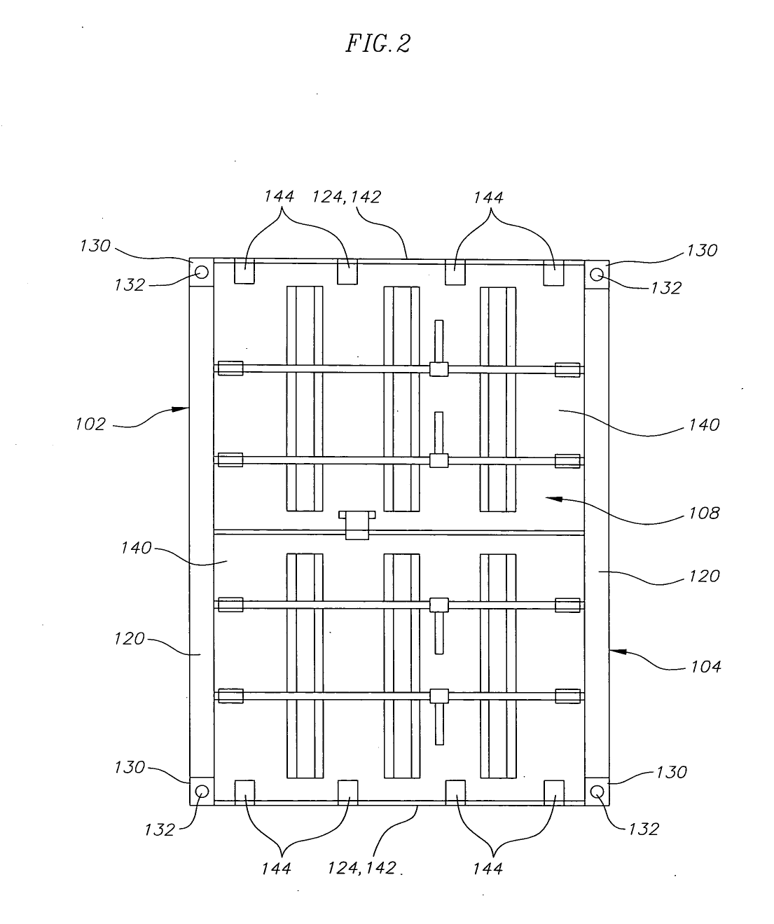

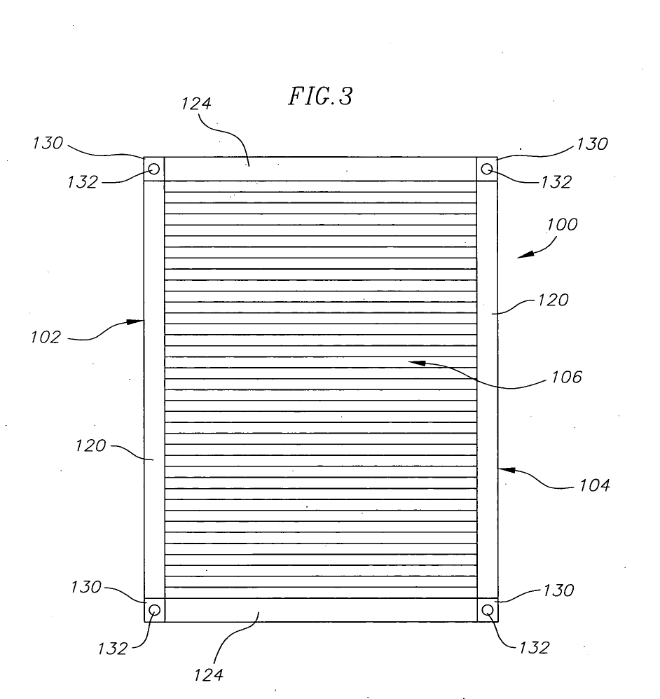

With reference to FIGS. 1-3, a shipping container 100 for the transport or storage of goods includes a roof 102 extending in a first direction along a length 116 of the shipping container 100 and extending in a second direction along a width 112 of the shipping container 100. The shipping container also has a base 104 opposite and substantially parallel to the roof 102. The base 104 also extends in a first direction along the length 116 of the shipping container 100 and in a second direction along the width 112 of the shipping container 100. The base 104 is configured to support goods transported or stored in the shipping container 100. The shipping container 100 also has a front end 106 connecting the roof 102 to the base 104, the front end 106 extending along the width 112 of the shipping container 100 and along a height 114 of the shipping container 100. A back end 108 of the shipping container 100 connects the roof 102 to the base 104 and is opposite the front end 106. The back end 108 also extends along the width 112 of the shipping container 100 and along the height 114 of the shipping container 100. The shipping container 100 also has two side panels 110 spaced apart from each other and substantially parallel. The two side panels 110 connect the roof 102 to the base 104 and are substantially perpendicular to each of the roof 102 and the base 104. Each of the two side panels 110 also connect the front end 106 to the back end 108. The side panels 110 extend along the length 116 of the shipping container 100 and along the height 114 of the shipping container 100.

In the present embodiment, the width 112 of the shipping container 100 is between approximately 8½ feet (2.59 m) and approximately 10 feet (3.05 m). The height 114 of the shipping container 100 is approximately 8 feet (2.44 m). Also, in preferred embodiments, the length 116 of the shipping container 100 is approximately 20 feet (6.10 m) or approximately 40 feet (12.19 m). In alternative embodiments, the width 112 and the length 116 of the shipping container 100 may be varied according to the storage requirements of the shipping container 100.

The roof 102, front end 106, and side panels 110 of the shipping container 100 are panels and may be formed from an anti-corrosive steel or other suitable material. The panels of the roof 102, front end 106, and side panels 110 may have a thickness of 2.0 mm, 1.6 mm, or any other suitable thickness. In the present embodiment, the panels of the roof 102, front end 106, and side panels 110 are corrugated in order to provide structural rigidity to the shipping container 100.

The shipping container 100 includes top side rails 117 and bottom side rails 119 extending horizontally along the length of the shipping container 100. The roof 102 of the shipping container 100 extends between the top side rails 117, and the base 104 of the shipping container 100 extends between the bottom side rails 119. The top and bottom side rails 117, 119 are made of an anti-corrosive steel or other suitable material and may be formed from square or rectangular tubing or any other structural form providing suitable strength and support. The panels of the roof 102 and side panels 110 of the shipping container are welded to the top and bottom side rails 117, 119.

The base 104 of the shipping container 100 includes cross members placed laterally along a bottom surface of the shipping container 100 at predetermined intervals to provide structural support to the shipping container 100 and to provide an offset between a surface on which the shipping container 100 rests and an inside area of the shipping container 100. Such an offset allows contents of the shipping container 100 to remain dry should moisture collect around the bottom surface of the shipping container 100. The cross members are welded to each of the bottom side rails 119. The base 104 also includes a floor extending between the bottom side rails 119. The floor may be formed of hardwood plywood, for example. The cross members are secured to a bottom surface of the floor by fasteners or another suitable technique or device. The base 104, according to an embodiment of the present invention, may be as described in U.S. Publication No. 2007/0138173.

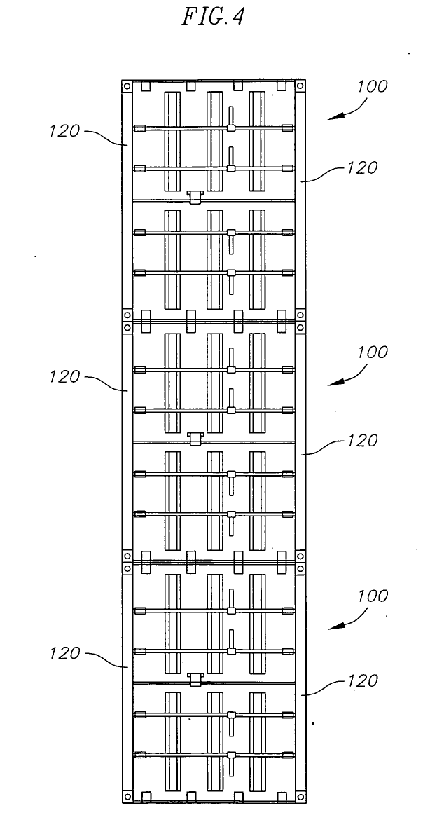

The shipping container 100 includes two pairs of corner posts 120 designed to bear the load of the shipping container 100, particularly as shipping containers 100 are stacked one on top of another in a container cell of a ship or on a loading dock. The corner posts 120 have high strength and may be formed from rolled high tensile steel, for example. Each of the corner posts 120 has a length in a direction substantially perpendicular to the two side panels 110 of the shipping container 100, the length being approximately equal to the width 112 of the shipping container 100. Such a configuration, as shown in FIGS. 1-4, allows the corner posts 120 to provide maximum strength when the shipping container 100 is stacked on one of its side panels 110 (see FIG. 4). In the embodiment shown in FIGS. 1-4, one of the first pair of corner posts 120 is connected to the front end 106 and the roof 102; one of the first pair of corner posts 120 is connected to the front end 106 and the base 104; one of the second pair of corner posts 120 is connected to the back end 108 and the roof 102; and one of the second pair of corner posts 120 is connected to the back end 108 and the base 104. The corner posts 120 are connected to the various panels as described above by welding.

The shipping container 100 also includes two pairs of end rails 124 extending vertically along the height of the shipping container 100, such that each of the end rails 124 has a length in a direction substantially perpendicular to each of the roof 102 and the base 104 of the shipping container 100. The end rails 124 are made of an anti-corrosive steel or other suitable material and may be formed from square or rectangular tubing or any other structural shape providing suitable strength and support. In the embodiment shown in FIGS. 1-4, one of the first pair of end rails 124 is connected to the front end 106 and one of the two side panels 110; one of the first pair of end rails 124 is connected to the front end 106 and the other of the two side panels 110; one of the second pair of end rails 124 is connected to the back end 108 and one of the two side panels 110; and one of the second pair of end rails 124 is connected to the back end 108 and the other of the two side rails 110. The end rails 124 are connected to the various panels as described above by welding.

Each of the end rails 124 is configured to support a compressive load applied to the end rail 124 in a direction substantially parallel to the direction of the length of the end rail 124. Also, each of the corner posts 120 is configured to support a compressive load applied to the corner post 120 in a direction substantially parallel to the direction of the length of the corner post 120, such as a load that is applied to each of the corner posts 120 when another shipping container is stacked on one of the side panels 110 of the shipping container 100. In present embodiments of the invention, the geometries and materials of construction of the corner posts 120 and the end rails 124 are such that the end rails 124 will fail under a compressive load less than the least compressive load under which the corner posts 120 will fail.

The corner posts 120 also provide structural support for lifters or a crane, which grasp the shipping container 100 at corner fittings 130 and the corner posts 120 to stack and/or transport individual shipping containers 100 at a loading dock or on a ship, as is known in the art. Corner fittings 130 are located at ends of the corner posts 120. The corner fittings 130 include openings 132 for engagement by the lifters or crane. The corner fittings 130 are formed of casted weldable steel, for example. The corner posts 120 and the top and bottom side rails 117, 119 are welded to the corner fittings 130.

The shipping container 100 also has at least one door 140 providing access to an inside area of the shipping container 100. In the present embodiment, the shipping container 100 includes two hinged doors 140 located at the back end 108 of the shipping container 100. Alternative embodiments may include at least one door 140 located at the front end 106 of the shipping container 100, replacing the panel of the front end 106 described above, as opposed to, or in addition to, the at least one door 140 located at the back end 108. For example, one embodiment of a shipping container 100 may include two hinged doors 140 located at the back end 108 and two hinged doors 140 located at the front end 106 of the shipping container 100. The doors 140 are rotatable about axes substantially perpendicular to the roof 102 and the base 104 of the shipping container 100 and also substantially perpendicular to the direction of the lengths of the corner posts 120.

The shipping container 100 may also include door support posts 142, each door support post 142 supporting one of the hinged doors 140 and having a length in a direction substantially perpendicular to the roof 102 and the base 104 of the shipping container 100. The length of each door support post 142 is approximately equal to the height 114 of the shipping container 100. Each of the door support posts 142 may be connected to one of the side panels 110, either the back end 108 or front end 106, and/or one of the end rails 124 of the shipping container 100. Alternatively, the door support posts 142 may be combined with the end rails 124 into unitary structural members. In addition to supporting the doors 140, the door support posts 142 provide strength and structural rigidity to the shipping container 100. The door support posts 142 may be formed from a rectangular bar, for example, or other suitable structural shape. In the present embodiment, each of the two hinged doors 140 is connected to one of the door support posts 142 by at least one hinge 144. The doors 140, the door support posts 142, and the hinges 144 may be formed from an anti-corrosive steel or other suitable material, and may be connected as described above by welding.

The shipping container 100 may also include forklift pockets 160. The shipping container 100 may be lifted using the forklift pockets 160 located along a lower edge of the shipping container 100, near a surface on which the shipping container 100 rests. The forklift pockets 160 extend laterally along the base 104 of the shipping container 100, and are spaced along the length of the shipping container 100 to allow for engagement with a forklift, which lifts the shipping container 100 as known in the art. In the area of the forklift pockets 160, openings are cut in the bottom side rails 119 through which prongs of a forklift may pass into the forklift pockets 160.

FIG. 4 shows three shipping containers 100 according to an embodiment of the present invention stacked one upon another, as the shipping containers 100 would be positioned in a container cell of a ship during transport, or as they may be stored at a loading dock or other storage area. The shipping containers 100 are stacked on one of their side panels 110. Because the orientation of the corner posts 120, as described above, is such that the direction of the lengths of the corner posts 120 is perpendicular to the side panels 110 of the shipping containers 100, the compressive load of the stacked shipping containers 100 is applied in a direction substantially parallel to the lengths of the corner posts, and is thereby supported by the corner posts 120.

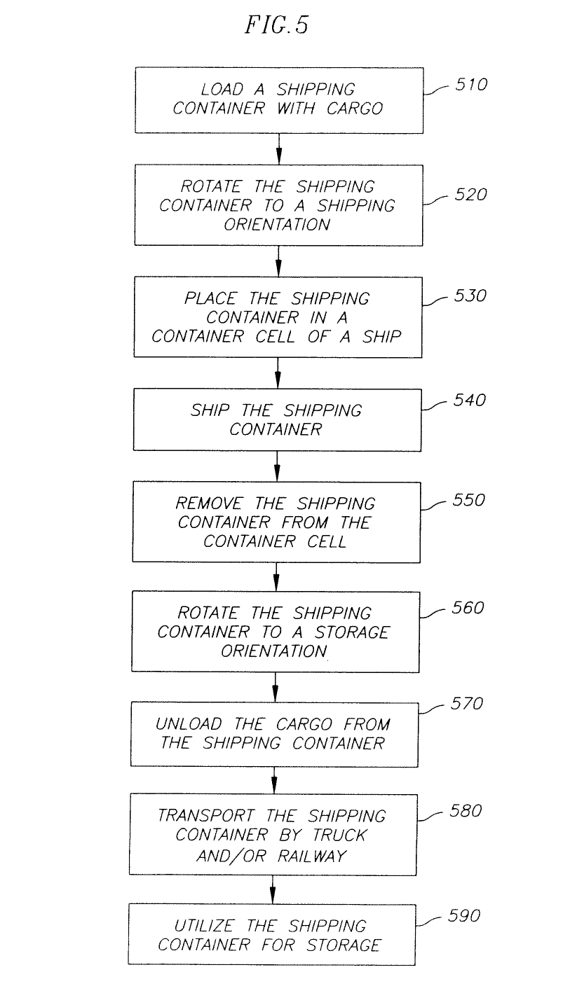

With reference to FIG. 5, a flow diagram of a method 500 for shipping extended width shipping containers is shown. In task 510, a shipping container having a height of approximately 8 feet (2.44 m) and a width between approximately 8½ feet (2.59 m) and approximately 10 feet (3.05 m) is loaded with cargo in the inside area of the shipping container such that the cargo is supported by a floor of the shipping container. The shipping container has at least one door that is rotatable about a vertical axis while the floor of the shipping container is parallel to and nearest the ground. In such an orientation, the shipping container is in a storage orientation. The cargo may be any goods or items desired to be shipped, including other containers. The cargo may be loaded manually, by forklift, by crane, by conveyor belt, or by any other technique, or combination thereof, suitable for loading cargo into a shipping container.

Task 520 includes rotating the shipping container on its side so that in the rotated orientation, the shipping container is approximately 8 feet (2.44 m) wide and stands between approximately 8½ feet (2.59 m) and approximately 10 feet (3.05 m) high. Additionally, in the rotated orientation, or shipping orientation, one of the shipping container's side panels is facing downward, and the floor of the shipping container is in a vertical orientation. Also, the at least one door of the shipping container is rotatable about a horizontal axis. The shipping container may be rotated by any suitable technique. Alternatively, task 520 may be performed prior to task 510.

In task 530, the shipping container is placed in a container cell of a ship in a shipping orientation, the container cell having a width of approximately 8 feet (2.44 m). Task 530 may further include stacking the shipping container on another shipping container already in the container cell, and/or subsequently stacking at least one additional shipping container on top of the placed shipping container. The shipping container may be placed in the container cell of the ship by using a forklift, crane, lifters, or any other suitable device or combination thereof.

In task 540, the shipping container is shipped over a body of water with the cargo loaded therein. The shipping container remains in the shipping orientation while being shipped.

In task 550, the shipping container is removed from the container cell of the ship. The shipping container may be removed from the container cell of the ship by using a forklift, crane, lifters, or any other suitable device or combination thereof.

In task 560, the shipping container is rotated back to the storage orientation so that the floor is on the bottom, the shipping container is between approximately 8½ feet (2.59 m) and approximately 10 feet (3.05 m) wide and approximately 8 feet (2.44 m) high, and the at least one door is rotatable about a vertical axis. The shipping container may be rotated by any suitable technique.

Task 570 includes unloading at least some of the cargo from the shipping container upon arrival at a shipping destination. The cargo may be unloaded manually, by forklift, by crane, by conveyor belt, or by any other technique, or combination thereof, suitable for unloading cargo from a shipping container. Alternatively, task 570 may be performed prior to task 560.

In task 580, the shipping container may be transported over land, such as by truck and/or railway, to another destination after having reached a shipping destination by sea. Transporting a shipping container by truck and/or railway according to task 580 may also be performed before the shipping container is shipped by sea. Alternatively, task 580 may be performed prior to task 560 and/or task 570.

In task 590, the shipping container may be utilized for storage of goods after the shipping container has been shipped to a shipping destination. The goods stored may be the same goods that were loaded into the container before shipping if task 570 is omitted. While used for storage of goods, the shipping container is in its storage orientation.

The present invention may be used according to an advantageous financing model. The shipping container 100 may be constructed at a shipping origin. The shipping container 100 may be used to ship cargo across seas from the shipping origin to a shipping destination. The shipping container 100 may be rented to a shipping company, which then uses the shipping container 100 for shipping cargo from the shipping origin to the shipping destination. The shipping container 100 may be sold to a third party, preferably at the shipping destination, for use in shipping across sea or land, or sold as a container for the storage of goods, as would most likely be the case for extended width shipping containers 100, as described above. In this manner, the manufacturer or seller of shipping containers 100 can transfer shipping containers 100 from the shipping origin to the shipping destination without having to pay shipping costs associated with transporting the shipping containers 100 as cargo. One-way rental of the shipping containers 100 also precludes the necessity of having to pay the costs associated with returning the shipping containers 100 to the shipping origin.

Although the present invention has been described in certain specific embodiments, many additional modifications and variations would be apparent to those skilled in the art. For example, the corner posts 120 or forklift pockets 160 may have other configurations or structures. Also, as another example, the tasks of the method 500 for shipping an extended width shipping container may be performed in a different order than the one described above and shown in FIG. 5. Furthermore, some of the tasks of the method 500 for shipping an extended width container may be omitted, or additional tasks not described above may be included, without departing from the invention.

It is therefore to be understood that this invention may be practiced otherwise than as specifically described. Thus, the present embodiments of the invention should be considered in all respects as illustrative and not restrictive, the scope of the invention to be determined by the claims supported by this application and the claims' equivalents.

What is claimed is:

1. A shipping container comprising:
a roof;
a base opposite the roof;
a front end connecting the roof to the base;
a back end opposite the front end, the back end connecting the roof to the base;
two spaced apart side panels substantially perpendicular to and connecting the roof to the base and substantially perpendicular to and connecting the front end to the back end;
at least one door rotatable about at least one door rotation axis substantially perpendicular to the roof and the base, the at least one door coupled to the back end;
two pairs of end rails, each of the end rails connected to one of the ends and one of the two side panels and having a length in a direction substantially perpendicular to the roof and the base; and
two pairs of corner posts, each of the corner posts connected to one of the ends and one of the group consisting of the roof and the base, each of the corner posts having a length in a direction substantially perpendicular to the two side panels and the at least one door rotation axis;
wherein:
each of the end rails is configured to support an end rail compressive load applied to the end rail in a direction substantially parallel to the direction of the length of the end rail, the end rail compressive load equal to any load less than an end rail failure load;
each of the corner posts is configured to support a corner post compressive load applied to the corner post in a direction substantially parallel to the direction of the length of the corner post, the corner post compressive load equal to any load less than a corner post failure load; and
the corner post failure load is greater than the end rail failure load.

2. The shipping container of claim 1, wherein the shipping container has a width between approximately 8½ feet (2.59 m) and approximately 10 feet (3.05 m) and a height of approximately 8 feet (2.44 m).

3. The shipping container of claim 2, wherein the shipping container has a length of approximately 20 feet (6.10 m).

4. The shipping container of claim 2, wherein the shipping container has a length of approximately 40 feet (12.19 m).

5. The shipping container of claim 1, further comprising at least one door support post supporting the at least one door, the at least one door support post having a length in a direction substantially parallel to the at least one door rotation axis.

6. The shipping container of claim 1, further comprising at least one front door rotatable about at least one front door rotation axis substantially perpendicular to the roof and the base, the at least one front door coupled to the front end.

7. The shipping container of claim 1, further comprising forklift pockets configured to facilitate lifting and supporting the shipping container by use of a forklift.

8. The shipping container of claim 1, further comprising corner fittings configured to facilitate lifting and supporting the shipping container by use of a crane or lifters.

9. A shipping container comprising:
two side panels opposite each other, each of the two side panels having a height of approximately 8 feet (2.44 m);
a base between approximately 8½ feet (2.59 m) and 10 feet (3.05 m) wide and substantially perpendicular to and connecting the two side panels, the base comprising a plurality of cross members and a floor supported by the plurality of cross members, the base configured to support a cargo load greater than can be supported by the two side panels;
two pairs of end rails, each of the end rails having a length in a direction substantially perpendicular to the base; and
two pairs of corner posts, each of the corner posts having a length in a direction substantially perpendicular to the two side panels;
wherein:
each of the end rails is configured to support an end rail compressive load applied to the end rail in a direction substantially parallel to the direction of the length of the end rail, the end rail compressive load equal to any load less than an end rail failure load;
each of the corner posts is configured to support a corner post compressive load applied to the corner post in a direction substantially parallel to the direction of the length of the corner post, the corner post compressive load equal to any load less than a corner post failure load; and
the corner post failure load is greater than the end rail failure load.

10. The shipping container of claim 9, further comprising at least one door rotatable about an axis substantially perpendicular to the base.

11. A method of shipping a shipping container having a height of approximately 8 feet (2.44 m), a width between approximately 8½ feet (2.59 m) and approximately 10 feet (3.05 m), a length in a direction of a length axis, at least one door, a storage orientation wherein the at least one door is rotatable about a vertical axis, and a shipping orientation wherein the at least one door is rotatable about a horizontal axis, the method comprising:
removing the shipping container from a container cell of a ship, the container cell having a width of approximately 8 feet (2.44 m), and the shipping container having been in the container cell in the shipping orientation; and
rotating the shipping container approximately ninety degrees about the length axis from the shipping orientation to the storage orientation.

12. The method of claim 11, further comprising:
placing the shipping container in the container cell of the ship in the shipping orientation; and
shipping the shipping container.

13. The method of claim 12, further comprising rotating the shipping container approximately ninety degrees about the length axis from the storage orientation to the shipping orientation before placing the shipping container in the container cell of the ship.

14. The method of claim 12, further comprising loading the shipping container with cargo before shipping the shipping container.

15. The method of claim 14, further comprising unloading at least some of the cargo from the shipping container after shipping the shipping container.

16. The method of claim 12, wherein placing the shipping container in the container cell of the ship comprises stacking the shipping container on another shipping container.

17. The method of claim 11, further comprising transporting the shipping container over land.

18. The method of claim 11, further comprising utilizing the shipping container for storage of goods after rotating the shipping container from the shipping orientation to the storage orientation.

19. The method of claim 11, further comprising renting the shipping container for shipping a load of cargo.

20. The method of claim 19, further comprising selling and delivering the shipping container after shipping the shipping container.
